(19) United States
(12) Patent Application Publication
(10) Pub. No.: US 2011/0125576 A1
(43) Pub. Date: May 26, 2011

(54) SERVING DYNAMIC ADVERTISMENTS BASED ON USER INTEREST OF A PRODUCT

(75) Inventors: Paxton Song, Los Altos, CA (US); Arnaud Tellier, Sunnyvale, CA (US)

(73) Assignee: Veruta, Inc., San Jose, CA (US)

(21) Appl. No.: 12/950,864

(22) Filed: Nov. 19, 2010

Related U.S. Application Data
(60) Provisional application No. 61/263,365, filed on Nov. 21, 2009.

(51) Int. Cl. G06Q 30/00

(52) U.S. Cl. 705/14.53

(57) ABSTRACT

In a method and system for serving dynamic advertisements, tracking data identifying a consumer computer system is placed on the consumer computer system. A user interaction with a first webpage viewed using the consumer computer system is recorded. A request for an advertisement to be displayed with a second webpage viewed using the consumer computer system is received. The request includes the tracking data. An advertisement containing content including at least a product, a service, or a brand is created. The content of the advertisement is selected for the consumer computer system identified by the tracking data. The content is selected based on the recorded user interaction.

### CROSS-REFERENCE TO RELATED APPLICATIONS

This application claims the benefit of U.S. Provisional Patent Application Ser. No. 61/263,365 filed Nov. 21, 2009, (“SERVING DYNAMIC ADVERTISEMENTS BASED ON USER INTEREST OF A PRODUCT”), which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright© 2009, Veruta, Inc. All Rights Reserved.

### TECHNICAL FIELD

Aspects of the present disclosure relate generally to Internet advertising, and more specifically, to a system and method to serve dynamic advertisements based on user interest of a product.

### BACKGROUND

One of the primary forms of web advertising is through banner advertisements (ads). Banner ads typically appear at or near the top of a web page. The banner ads can be delivered by an ad server that tracks the individual deliveries of the banner ads, thereby monitoring the reach of particular web advertising campaigns. The banner ads also represent a link to the advertiser's site, which can be reached by clicking on the banner ad.

### BRIEF DESCRIPTION OF DRAWINGS

Some embodiments are illustrated by way of example and not limitation in the figures of the accompanying drawings in which:

FIG. 1 is a block diagram illustrating a system for advertising over a network, according to an example embodiment.

FIG. 2 is a diagrammatic representation of a dynamic product advertisement server, as may be used in an example embodiment.

FIG. 3 is a diagrammatic representation of a data structure used to describe a product sold by a merchant, as may be used in an example embodiment.

FIG. 4 is an exemplary representation of a dynamic product advertisement, as may be used in an example embodiment.

FIG. 5 is a flow chart illustrating a method to record interest a user has for a product over a network, according to an example embodiment.

FIG. 6 is a flow chart illustrating a method to serve a dynamic advertisement based on a user's interest of a product, according to an example embodiment.

FIG. 7 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

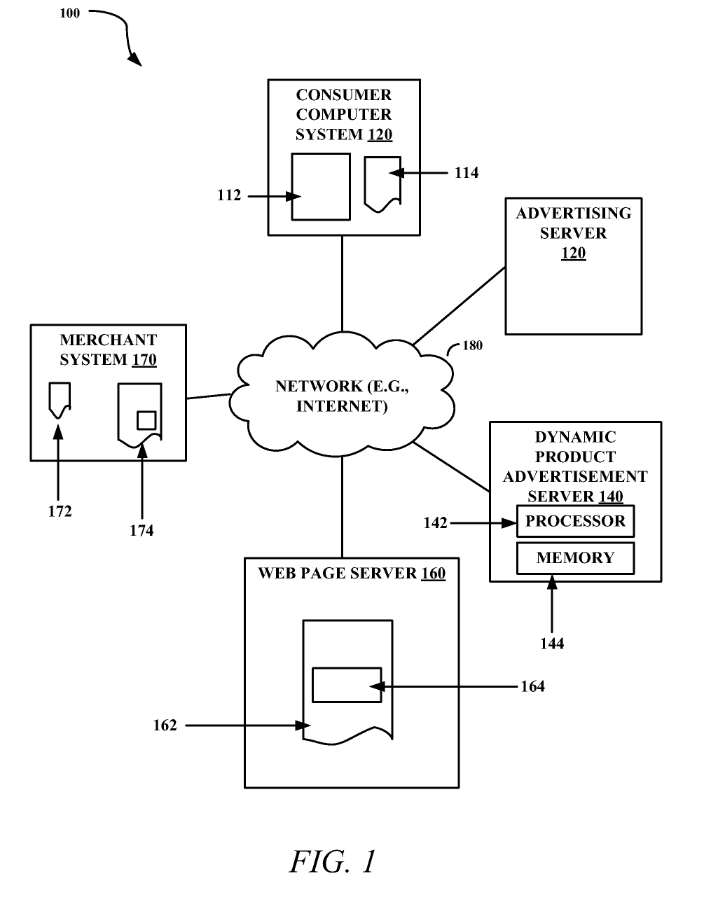

Referring to FIG. 1, a computer system is shown and is generally designated 100. As depicted, the system 100 includes an end-user or consumer computer 110, a webpage server 160, a merchant system 170, an advertisement server 120, and a dynamic product advertisement (DPA) server 140. As depicted, the consumer computer system 110, the webpage server 160, the merchant system 170, the advertisement server 120, and the DPA server 140 are coupled via a wide area network (WAN), e.g., the Internet 180.

As shown, a browser 112 and tracking data 114 are disposed within the consumer computer system 110. The browser 112 is a software application for retrieving, presenting, and traversing information resources on the World Wide Web. In an example embodiment, the browser 112 and the tracking data 114 are embedded within a computer readable storage medium, e.g., a memory, within the consumer computer system 110.

The tracking data 114 allows the advertisement server 120 and the DPA server 140 to identify the browser 112 as a requester of services. In an example embodiment, the tracking data 114 represents one or more web cookies stored on the consumer computer system 110. The web cookies each may contain an identifier that identifies the browser 112 or the consumer computer system 110 to the advertisement server 120 and the DPA server 140. In another example embodiment, a web page viewed by the browser 112 has query strings embedded in the links of the web page. In this way, when the user follows a link, the browser 112 returns the attached query string to the servers 120 and 140. In other example embodiments, any number of well known tracking techniques can be employed for identifying session data. By way of example and not limitation, these techniques can include hidden forms, IP address tracking, and the window.name property found in JavaScript and DOM objects, to name a few techniques.

The webpage server 160 includes web content 162. The webpage server 160 allows delivery of the web content 162 based on requests, for example, from the browser 112 executing on the consumer computer system 110. Further, the web content 162 includes an advertisement unit 164. Among other things, the advertisement unit 164 may instruct the browser 112 to request the advertisement server 120 to serve a static or dynamic advertisement. In an example embodiment, the web content 162 is a file (e.g., HyperText Markup Language (HTML)) stored in a computer readable storage medium. In another example embodiment, the web content 162 may be dynamically created upon receiving a request for the webpage 162 from the browser 112. In the case that the web content 162 is dynamically created, any of the techniques for embedding the tracking data 114 described above may be utilized by the webpage server 160.

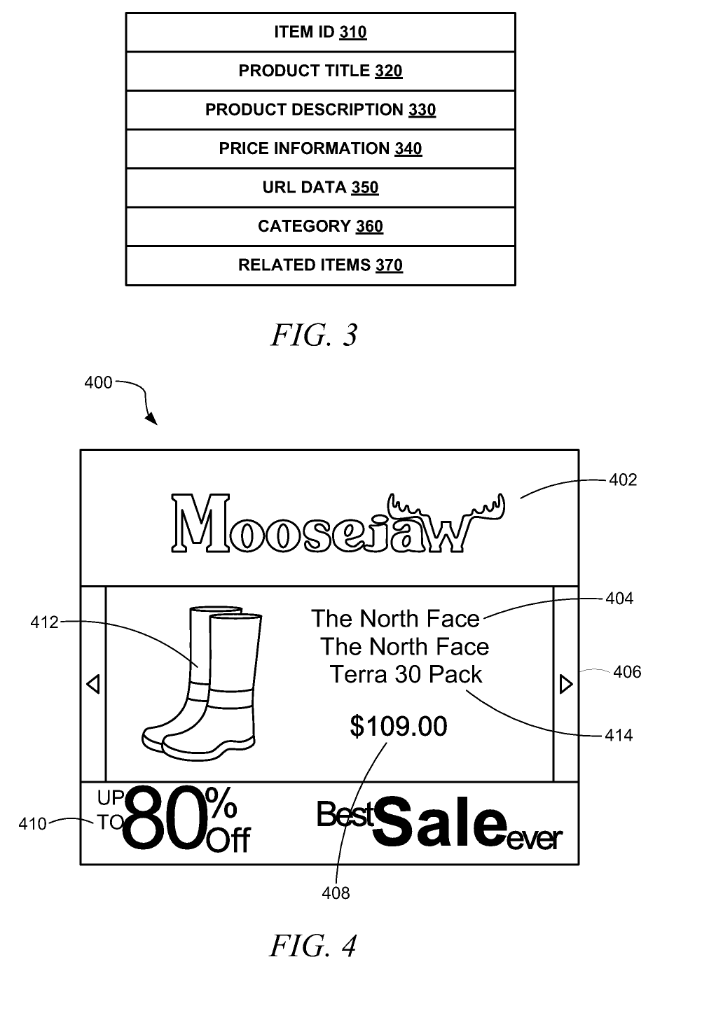

The merchant system 170, as illustrated in FIG. 1, includes merchant inventory information 172 and merchant content 174. In an example embodiment, the merchant inventory information 172 is a data collection including information related to one or more of the products or services sold or advertised by the merchant system 170. The merchant system 170 transmits the inventory information 172 to the DPA server 140. In an example embodiment, the merchant system 170 communicates the merchant inventory information 172 to the DPA server 140 via a product feed, such as a data feed or data file. The product feed may be pushed or pulled from email (e.g., in the body or as an attachment) or from the merchant server 170 via any known network protocol, e.g., ftp, sftp, http, https, or a web service API. In example embodiments, the merchant inventory information 172 could be pulled periodically, manually, or based on conditions defined by the DPA server 140 or the merchant system 170. FIG. 3, described below, defines a suitable data format for the data elements of the inventory information 172.

As depicted, the merchant system 170 includes merchant content 174. Merchant content 174 provides product information to a consumer traversing the Internet 180 using browser 112. The merchant content 174, in an example embodiment, can be a collection of HTML files containing product, brand, or service information. In another example embodiment, the merchant content 174 can be dynamically constructed by the merchant system 170 in response to a user traversing the interne 180 using the browser 112.

FIG. 1 further illustrates that the merchant content 174 embeds the merchant product data 175-177. The merchant product data 175-177 instructs the merchant content 174 to provide product interest information and the tracking data 114 to the DPA server 140. Each of 175-177 may correspond to different or the same products or services offered by the merchant system 170. In other example embodiments, merchant product data 175 may suggest the types of products or services that may be of interest to the consumer. For example, if merchant content 174 includes sporting information, merchant product data 175 may indicate that the consumer may be interested sporting products.

In an example embodiment, the merchant product data 175-177 can be in the form of hidden HTML tables that transmit product data to the DPA server 140 via one or more HTTP POST or GET commands. In another example embodiment, the merchant product data 175-177 can be in the form of JavaScript that scans HTML and DOM content attributed to the merchant content 174, as well as the actual URL of the page, to extract the relevant product information.

In yet another embodiment, merchant product data 175-177 may additionally be based on contextual information related to the consumer viewing activities on the browser 112. One such example of a viewing activity is whether the consumer places the cursor indicator of computer system 110 over a rendered product displayed on the browser 112 as detected by JavaScript, for example. In other example embodiments, merchant product data 175-177 may indicate whether the cursor was placed over product information for a period of time that exceeds some threshold (several seconds, for example) or, in another embodiment, whether product information was clicked on.

The advertisement server 120 is configured to receive advertisement requests from the advertisement unit 164 of the webpage 162. The advertisement server 120 is capable of uniquely identifying the tracking data 114 corresponding to the consumer computer system 110 and, depending on the tracking data 114, request the DPA server 140 to serve a dynamic product advertisement to be displayed within webpage 162. In an example embodiment, if a portion of the tracking data 114 indicates that the DPA server 140 is capable of servicing the advertisement request, the advertisement server 120 will forward the advertisement request to the DPA server 140. In an example embodiment, a portion of the tracking data 114 is represented in the form of a web cookie placed on the consumer computer system 110 by the DPA server 140.

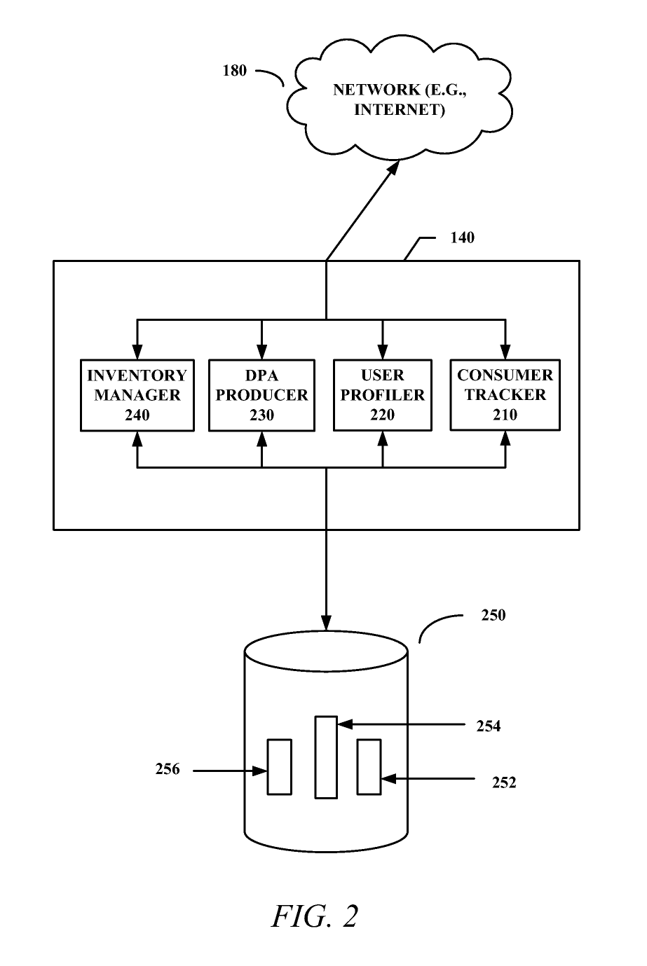

In an example embodiment, the DPA server 140 includes a processor 142 and a computer readable storage medium, e.g., a memory 144, that is coupled to the processor 142. As will be further described in FIGS. 2-4, the DPA server 140 is configured to receive the merchant inventory 172, send the tracking data 114 to the consumer computer system 110, and record product interest data based on the browser 112 visiting the merchant content 174. Further, in response to a request from advertisement server 120, the DPA server 140 is configured to create dynamic product advertisements based on product interest of a consumer who previously visited the merchant content 174.

Referring now to FIG. 2, the DPA server 140 includes a consumer tracker 210, a DPA producer 220, a user profiler 230, and an inventory manager 240. Each of the consumer tracker 210, the DPA producer 220, the user profiler 230, and the inventory manager 240 may be implemented by one or more processors of the DPA server 140. In addition, the DPA server 140 is coupled to a product interest database 250. FIG. 2 further illustrates that the product interest database 250 stores user identifier data 252, user profile data 254, and inventory data 256.

In an example embodiment, the consumer tracker 210 is configured to create and associate the tracking data 114 with the end user 110. As described above, when the browser 112 traverses the merchant content 174, the browser 112 will transmit the corresponding merchant product data, e.g. 175, to the DPA server 140. At the same time, the browser 112 will also transmit the tracking data 114, if available. In the event the tracking data 114 is not available—e.g., the data 114 has been deleted—the consumer tracker 210 will create the tracking data 114 and transmit the tracking data 114 to the consumer computer system 110. Additionally, once the tracking data 114 is created, the consumer tracker 210 stores the tracking data 114 in the user identifier data 252.

In an example embodiment, the consumer tracker 210 may transmit the tracking data 114 to the consumer computer system 110 in the form of a cookie. As such, the cookie transmitted in the request headers will identify the consumer using the consumer computer system 110. In another example embodiment, the tracking data 114 may be transmitted to the DPA server 140 directly in the URL for the request.

The user profiler 230 is configured to receive the merchant product data 175-177 and the tracking data 114, which the browser 112 transmits when traversing the merchant content 174. In response to receiving the merchant product data 175-177 and the tracking data 114, the user profiler 230 updates the user profile data 254.

In an example embodiment, the user profile data 254 may record a number of different statistics related to a consumer browsing activities related to the merchant content. For example, the user profile data 254 may include the number of times merchant product data 175 was viewed, number of times merchant product data 175 was bought, number of time merchant product data 175 was added to the cart, number of times merchant product data 175 was searched. User profile data 254 also may include user browsing behavioral data, such as the amount of time a user spends on a certain web page, the web page elements that a user interacts with via a user input device, and the amount of time that a user spends interacting with a web page element.

The inventory manager 240 is configured to the receive inventory information 172 from the merchant system 170. As described above, the merchant system 170 transmits the inventory information 172 to the DPA server 140. In an example embodiment, the merchant system 170 communicates the merchant inventory information 172 to the DPA server 140 via a product feed, such as a data feed or data file. The product feed may be pushed or pulled from email (e.g., in the body or as an attachment) or from the merchant server 170 via, e.g., ftp, sftp, http, https, or a web service API. In example embodiments, the merchant inventory information 172 could be pulled periodically, manually, or based on conditions defined by the DPA server 140 or the merchant system 170.

The DPA producer 220 is configured to create dynamic product advertisements based on a combination of one or more of the user identifier data 252, the user profile data 254, and the inventory data 256. The following exemplary steps are provided to illustrate how the DPA producer 220 creates dynamic product advertisements. First, the browser 112 traverses the merchant content 174. In response to being rendered by the browser 112, the merchant content 174 directs the browser 112 to transmit the merchant product data 175 and the tracking data 114 to the DPA server 140. The DPA server 140 receives the merchant product data 175 and tracking data 114 pair and stores this information in the user profile data 254. At a later point in time, the browser 112 may traverse the web content 162, which includes the advertisement unit 164. To render the advertisement unit 164, the browser may request content from the advertisement server 120. Since the request for the advertisement content includes the tracking data 114, the advertisement server 120 may delegate service to the DPA server 140. At this point, the DPA producer 220 may query the user profile data 254 for the recorded browsing activities that match the tracking data 114.

According to the above exemplary steps, the user profile data 254 would return browsing activities related to the merchant product data 175. Using inventory data 256 that matches the returned browsing activities, the DPA producer 220 can serve a dynamic product advertisement that includes information of interest to the consumer operating the browser 112.

Accordingly, the system 100 provides an improved system for dynamically creating advertisements based on consumer interest in a product or service, expressed by browsing activities relative to displayed web pages.

One suitable data format for the elements of the inventory information 172 is shown in FIG. 3. As shown, the product data 300 includes seven fields of information. The order of the fields can be varied as desired as well as the content of each field. FIG. 3 is intended only to be exemplary of one possible product data format; many other formats exist as would be appreciated by those skilled in the art.

Referring still to FIG. 3, field 310 may include an item identifier value. This value may be a number automatically generated to provide system 100 with a means to indicate a product. Field 320 may include a product title value, which represents the name of the product in a human-readable format, e.g., a string of ASCII of characters. Field 330 may include a product description value, which describes the product in a human-readable format, e.g., a string of ASCII of characters. Field 340 may include a price information value, which indicates the numerical price of the product. Field 350 may include a URL value, which identifies the webpage an Internet user may wish to visit, for example, to get further information related to the product or to purchase the product. Field 360 may include a category value, which identifies that product category of the product. For example, field 360 for a golf club may contain a value representing “Sporting Goods.” Accordingly, in an example embodiment, DPA server 140 could include additional advertisements for products that likewise are under the “Sporting Goods” category. Field 370 may include a related items value, which identifies products that, although not necessarily under the same category, may be otherwise related. Or, in an example embodiment, related item field 370 may represent a stronger relationship than the category field 360. For example, in an example embodiment, a product for a golf club may indicate via the related item field 370 that a golf ball product is a related item. As a result, DPA server 140 could generate advertisements for related products based on this field.

As mentioned above, FIG. 3 is intended only to be exemplary of one possible product data format and many other formats may exist. As would be appreciated by those skilled in the art, product data 300 could contain as few as one element (e.g., the item id field 310). Alternatively, many more fields may be included. By way of example and not limitation, other fields may include the product's stock-keeping unit (SKU), quantity available, shipping information, special offers, and calculated weight.

FIG. 4 illustrates an exemplary dynamic product advertisement 400 served by the DPA server 140. There are several elements to the dynamic product advertisement 400, including a brand name area 402, a product area 412, and a promotional area 410.

In example embodiments, the brand name area 402 typically consists of an image or some html code or some flash widget that displays the logo of the merchant system 170. The promotional area 410 could be static or dynamic. In an example embodiment, the promotional area 410 could be based on the user profile data 254, and/or on the inventory data 256, or be dynamically generated from the list of items displayed in the product area 412. An example embodiment could compute the highest discount from the list of products that the DPA producer 220 has placed in the in the product area 412.

Additionally, in some embodiments, the promotional area 410 may display advertisements based on the consumer associated with tracking data 114 having experienced certain events, such as: number of ads shown, number of engagements, clicks, time spend of some pages on the web site, and price of the interested items.

The product area 412 is a dynamic portion of the dynamic product advertisement 400 and includes one or more products that the DPA producer selects to advertise based on the user profile data 254 and the inventory data 256. The product area 412 is comprised of one or more of the following—the product image 412, the product title 404, MSRP (not shown), the sale price 408, the product description 414, discount (not shown), special promotions (not shown).

In example embodiments, the dynamic product advertisement 400 could periodically update advertisement content displayed by one or more of the brand name area 402, the product area 412, and the promotional area 410. For example, in an example embodiment, the brand name area 402 can rotate messages by showing a different message at a specified frequency. In another example embodiment, the dynamic product advertisement 400 could simultaneously update the brand name area 402, the product area 412, and the promotional area 410 with new content.

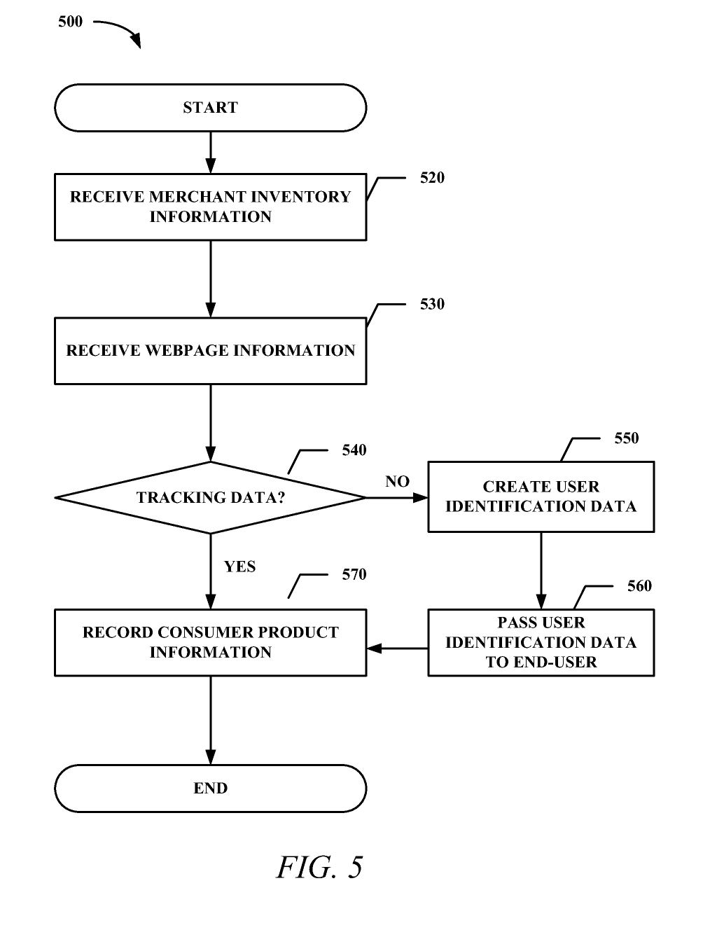

FIG. 5 is a flow chart illustrating a method 500, in accordance with an example embodiment, to record interest a user has for a product over a network. The method 500 may be performed by any of the modules, logic, or components described herein.

The method 500 commences at operation 520 with the DPA server 140 receiving the merchant inventory information 172 from the merchant system 170. The merchant inventory information 172 may be pushed or pulled from email (e.g., in the body or as an attachment) or merchant server 170 (e.g., via ftp, sftp, http, https, or a web service API). In example embodiments, the merchant inventory information 172 could be pulled periodically, manually, or based on conditions defined by the DPA server 140 or the merchant system 170.

At operation 530, the DPA server 140 receives the merchant product data 175 (although merchant product data can come from any one of the set of 175, 176, or 177, 175 is used for explanation purposes) and the tracking data 114. In an example embodiment, the merchant system 170 transmits the merchant product data 175 to the DPA server 140 when generating merchant content 174. In an example embodiment, the merchant system 170 transmits the merchant product data 175 by adding or replacing parts of the URL. In yet another example embodiment, merchant system transmits the merchant product data 175 by replacing or adding parts of the html source of merchant content 174. By way of example but not limitation, the merchant system 170 may add or replace tags or parts of the JavaScript code embedded in the merchant content 174.

At decision 540, the consumer tracker 210 determines whether the tracking data 114 was included with the merchant product data 175. If the consumer tracker 210 locates the tracking data 114 with the merchant product data 175, processing continues to operation 570. Otherwise a branch is made to operation 550.

At operation 550, the consumer tracker 210 creates a tracking data 114 that uniquely identifies the consumer computer system 110. As described above, some example embodiments will create a web cookie that will uniquely identify the browser 112 traversing the merchant content 174. At operation 560, the DPA server 170 passes the newly created the tracking data 114 to the consumer computer system 110.

At operation 570, user profiler 230 records consumer interest based on storing at least a portion of the merchant product data 175 and the tracking data 114 in user profile data 254.

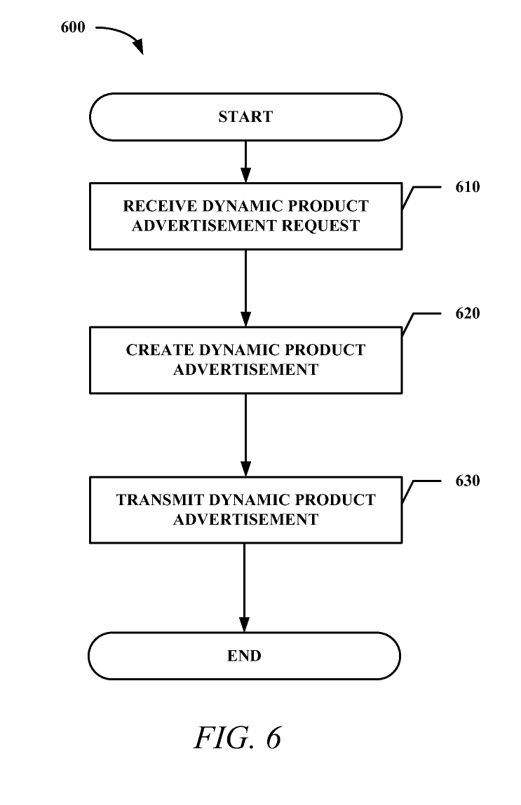

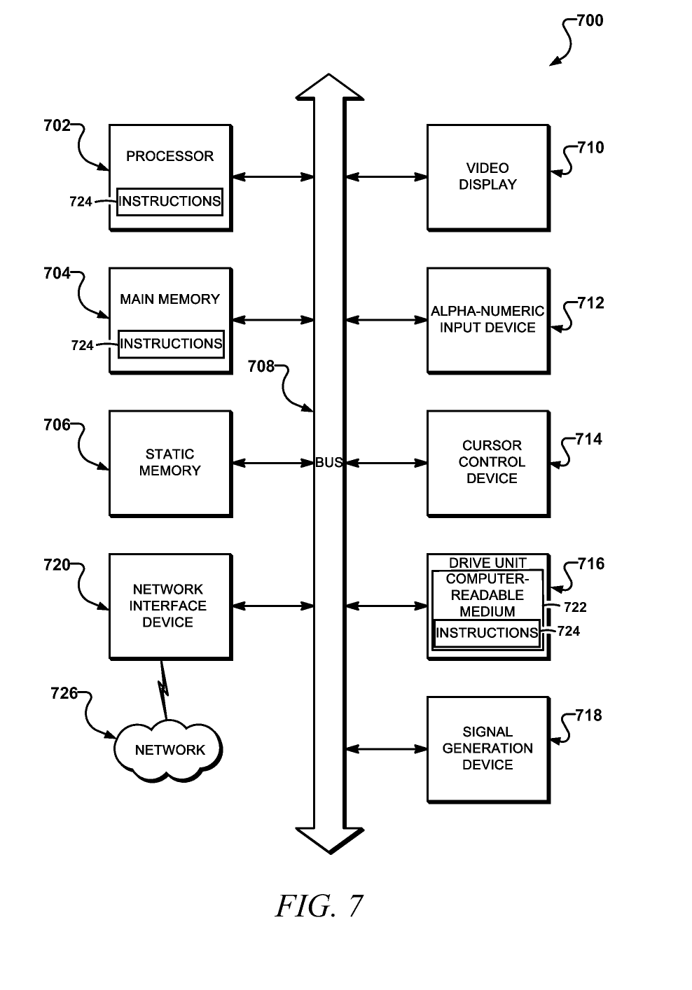

FIG. 6 is a flow chart illustrating a method 600, in accordance with an example embodiment, to serve a dynamic advertisement based on a user's interest of a product. The method 600 may be performed by any of the modules, logic, or components described herein.

The method 600 commences at operation 610 with the DPA server 140 receiving a request to serve a dynamic product advertisement from the advertisement unit 164 located in the web content 162, now loading on the browser 112. In an example embodiment, the request for a dynamic product advertisement includes the tracking data 114. In an example embodiment, the request to serve the dynamic product advertisement may come indirectly from the advertisement server 120.

At operation 620, the DPA producer 220 generates the dynamic product advertisement based on the user profile data 254 and the inventory data 256. In an example embodiment, the DPA producer 220 queries the user profile data 254 for recorded interests related to the tracking data 114.

At operation 639, the DPA server 140 transmits the created dynamic product advertisement to the browser 112. In an example embodiment, the request to serve the dynamic product advertisement may come indirectly from the advertisement server 120.

Although the above example embodiments describe the system as including a single merchant system 170, other example embodiments may include a plurality of merchant systems. The DPA server 140 may, for example, uniquely identify a merchant system with a merchant identifier. This merchant identifier then could be stored in the product interest database 250, where the merchant identifier corresponds to specified inventory information 172. Moreover, the merchant product data 175-177 received by the DPA server 140 may likewise contain a merchant identifier to further associate portions of the user profile 254 with a specified merchant system. The above is intended only to be exemplary of one possible embodiment; many other embodiments exist as would be appreciated by those skilled in the art.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 3 is a block diagram of machine in the example form of a computer system 300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

### Machine-Readable Medium

The disk drive unit 316 includes a machine-readable medium 322 on which is stored one or more sets of instructions and data structures (e.g., software) 324 embodying or utilized by any one or more of the methodologies or functions described herein. The instructions 324 may also reside, completely or at least partially, within the main memory 304 and/or within the processor 302 during execution thereof by the computer system 300, the main memory 304 and the processor 302 also constituting machine-readable media.

While the machine-readable medium 322 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 324 may further be transmitted or received over a communications network 326 using a transmission medium. The instructions 324 may be transmitted using the network interface device 320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method for advertising, the method comprising:
placing tracking data on a consumer computer system, the tracking data identifying the consumer computer system;
recording a user interaction with a first webpage viewed using the consumer computer system;
receiving a request for an advertisement to be displayed with a second webpage viewed using the consumer computer system, the request including the tracking data; and
responsive to the request, creating the advertisement, the advertisement containing content including at least one of a product, a service, and a brand, the content being selected for the consumer computer system identified by the tracking data, and the content being selected based on the recorded user interaction.

2. The computer-implemented method of claim 1, further comprising:
receiving merchant inventory information, the merchant inventory information including information related to at least one product or service sold by the merchant; and
storing the merchant inventory information.

3. The computer-implemented method of claim 2, wherein the first webpage presents the merchant inventory information, and wherein the recorded user interaction with the first webpage comprises user interaction with the merchant inventory information.

4. The computer-implemented method of claim 1, wherein the recorded user interaction includes at least one of a selection of a webpage element of the first webpage by a user input device, a hovering of an indicator of the user input device over the webpage element, a first amount of time spent by the user input device interacting with the webpage element, and a second amount of time spent by the user input device interacting with the first webpage.

5. The computer-implemented method of claim 1, further comprising dynamically updating the content of the advertisement using the tracking data and the recorded user interaction.

6. The computer-implemented method of claim 1, wherein the recorded user interaction is stored as user profile information, the recorded user interaction comprising product interest information that identifies one or more products in which the user is determined to have an interest.

7. The computer-implemented method of claim 6, wherein the content of the advertisement is further selected by matching a first product sold by the merchant and identified in the merchant inventory information to a second product identified by the product interest data.

8. A non-transitory computer-readable storage medium storing a set of instructions that, when executed by a processor, causes the processor to perform operations, comprising:
placing tracking data on a consumer computer system, the tracking data identifying the consumer computer system;
recording a user interaction with a first webpage viewed using the consumer computer system;
receiving a request for an advertisement to be displayed with a second webpage viewed using the consumer computer system, the request including the tracking data; and
responsive to the request, creating the advertisement, the advertisement containing content including at least one of a product, a service, and a brand, the content being selected for the consumer computer system identified by the tracking data, and the content being selected based on the recorded user interaction.

9. The non-transitory computer-readable storage medium of claim 8, further comprising:
receiving merchant inventory information, the merchant inventory information including information related to at least one product or service sold by the merchant; and
storing the merchant inventory information.

10. The non-transitory computer-readable storage medium of claim 9, wherein the first webpage presents the merchant inventory information, and wherein the recorded user interaction with the first webpage comprises user interaction with the merchant inventory information.

11. The non-transitory computer-readable storage medium of claim 8, wherein the recorded user interaction includes at least one of a selection of a webpage element of the first webpage by a user input device, a hovering of an indicator of the user input device over the webpage element, a first amount of time spent by the user input device interacting with the webpage element, and a second amount of time spent by the user input device interacting with the first webpage.

12. The non-transitory computer-readable storage medium of claim 8, further comprising dynamically updating the content of the advertisement using the tracking data and the recorded user interaction.

13. The non-transitory computer-readable storage medium of claim 8, wherein the recorded user interaction is stored as user profile information, the recorded user interaction comprising product interest information that identifies one or more products in which the user is determined to have an interest.

14. The non-transitory computer-readable storage medium of claim 13, wherein the content of the advertisement is further selected by matching a first product sold by the merchant and identified in the merchant inventory information to a second product identified by the product interest data.

15. A system, comprising:
a memory storing a set of instructions; and
a processor executing the set of instructions to implement:
a consumer tracker configured to create tracking data and to transmit the tracking data to a consumer computer system, the tracking data identifying the consumer computer system;
a user profiler configured to receive the tracking data from the consumer computer system and to store a recorded user interaction with a first webpage viewed using the consumer computer system;
a dynamic advertisement producer configured to:
receive a request for an advertisement to be displayed with a second webpage viewed using the consumer computer system, the request including the tracking data; and
responsive to the request, create the advertisement, the advertisement containing content including at least one of a product, a service, and a brand, the content being selected for the consumer computer system identified by the tracking data, and the content being selected based on the recorded user interaction.

16. The system of claim 15, further comprising:
an inventory manager configured to receive and store merchant inventory information, the merchant inventory information including information related to at least one product or service sold by the merchant.

17. The system of claim 16, wherein the first webpage presents the merchant inventory information, and wherein the recorded user interaction with the first webpage comprises user interaction with the merchant inventory information.

18. The system of claim 15, wherein the recorded user interaction includes at least one of a selection of a webpage element of the first webpage by a user input device, a hovering of an indicator of the user input device over the webpage element, a first amount of time spent by the user input device interacting with the webpage element, and a second amount of time spent by the user input device interacting with the first webpage.

19. The system of claim 15, wherein the dynamic advertisement producer is further configured to dynamically update the content of the advertisement using the tracking data and the recorded user interaction.

20. The system of claim 15, wherein the recorded user interaction is stored as user profile information, the recorded user interaction comprising product interest information that identifies one or more products in which the user is determined to have an interest.

21. The system of claim 20, wherein the content of the advertisement is further selected by matching a first product sold by the merchant and identified in the merchant inventory information to a second product identified by the product interest data.
